(19) United States
(12) Patent Application Publication
(10) Pub. No.: US 2015/0275090 A1
(43) Pub. Date: Oct. 1, 2015

(54) UV Stable and Low-Voltage Liquid Crystal Microdroplet Display

(71) Applicant: Jiansheng Wang, The Colony, TX (US)

(72) Inventor: Jiansheng Wang, The Colony, TX (US)

(21) Appl. No.: 14/666,142

(22) Filed: Mar. 23, 2015

Related U.S. Application Data
(60) Provisional application No. 61/967,689, filed on Mar. 22, 2014.
(60) Provisional application No. 61/981,109, filed on Apr. 17, 2014.

(51) Int. Cl. C09K 19/54

(52) U.S. Cl. CPC C09K 19/544

(57) ABSTRACT

A LCMD device comprises a polymer matrix and droplets of liquid crystal material dispersed in the polymer, wherein the polymer matrix or the liquid crystal includes a UV absorber. The LCMD material may be formed by phase separation with a dissolved framework polymer.

### BACKGROUND OF INVENTION

1. Field of the Invention

This invention relates to a Liquid Crystal Micro-Droplet (LCMD) displays. More particularly, a display that is protected from ultraviolet radiation and that requires lower voltage to switch the liquid crystal and methods of making are provided.

2. Description of Related Art

Continued advancements in the field of optoclectronics have led to the development of liquid crystal microdroplet (LCMD) displays. In this type of display, liquid crystal (LC) material is contained in microdroplets embedded in a solid polymer matrix. Birefringence results from a material having a different index of refraction in different directions. The extraordinary index of refraction (nₑ) of a liquid crystal molecule is defined as that measured along the long axis of the molecule, and the ordinary index of refraction (nₒ) is measured in a plane perpendicular to the long axis. The dielectric anisotropy of liquid crystals is defined as Δ∈=∈_{∥}−∈_{⊥}, where ∈_{∥} and ∈_{⊥}, are parallel and perpendicular dielectric constants, respectively. Liquid crystals having a positive dielectric anisotropy (Δ∈>0) are called positive-type liquid crystals, or positive liquid crystals, and liquid crystals having a negative dielectric anisotropy (Δ∈<0) are called negative-type liquid crystals, or negative liquid crystals. The positive liquid crystals orient in the direction of an electric field, whereas the negative liquid crystals orient perpendicular to an electric field. These electro-optical properties of liquid crystals have been widely used in various applications.

One approach to obtaining dispersed microdroplets in a polymer matrix is the method of encapsulating or emulsifying the liquid crystals and suspending the liquid crystals in a film which is polymerized. This approach is described, for example, in U.S. Pat. Nos. 4,435,047; 4,605,284; and 4,707,080. This process includes mixing positive liquid crystals and encapsulating material, in which the liquid crystals are insoluble, and permitting formation of discrete capsules containing the liquid crystals. The emulsion is cast on a substrate, which is precoated with a transparent electrode, such as an indium tin oxide (ITO) coating, to form an encapsulated liquid crystal device.

LCMD displays may also be formed by phase separation of low-molecular weight liquid crystals from a prepolymer or polymer solution to form microdroplets of liquid crystals. This process, described in U.S. Pat. Nos. 4,685,771 and 4,688,900, includes dissolving positive liquid crystals in an uncured resin and then sandwiching the mixture between two substrates, which are precoated with transparent electrodes. The resin is then cured so that microdroplets of liquid crystals are formed and uniformly dispersed in the cured resin to form a polymer dispersed liquid crystal device. When an AC voltage is applied between the two transparent electrodes, the positive liquid crystals in microdroplets are oriented and the display is transparent if the refractive index of the polymer matrix (nₚ) is made to equal the ordinary index of liquid crystals (nₒ). The display scatters light in the absence of the electric field, because the directors (vector in the direction of the long axis of the molecules) of the liquid crystals are random and the refractive index of the polymer cannot match the index of the liquid crystals. Nematic liquid crystals having a positive dielectric anisotropy (Δ∈>0), large Δn, which may contain a dichroic dye mixture, can be used to form a transparent and absorbing mode.

LCMD displays may be characterized as normal mode or reverse mode displays. A normal mode display containing liquid crystals is non-transparent (scattering or absorbing) in the absence of an electric field and is transparent in the presence of an applied electric field. A reverse mode display is transparent in the absence of an electric field and is non-transparent (scattering or absorbing) in the presence of an applied electric field.

If an electric field is applied on a LCMD display, liquid crystals in microdroplets are not entirely perpendicular to the substrate. The central part of liquid crystals in the droplets is clear if the refractive index of the polymer matches the ordinary refractive index of the liquid crystals (nₒ). However, liquid crystals near the ends of the microdroplet are strongly bent because they are parallel to the skin of the inner layer. They are, therefore, tilted to the substrate surface, and the refractive index of the liquid crystals cannot match with the refractive indexes of the polymer matrix and inner layer. Therefore, parts of the liquid crystal droplets scatter light and produce haze.

There exists a need for devices that use improved LCMD technologies for various applications, including outdoor applications. Preferably, outdoor displays or panels are not significantly affected by ultraviolet radiation. There is also a need in all LCMD devices that the lowest possible voltage be required to switch the liquid crystal.

### BRIEF SUMMARY OF THE INVENTION

The present disclosure includes composition and methods for making LCMD devices that are highly resistant to deterioration by UV radiation. Compositions and methods for making LCMD devices that require lower voltage than prior art devices to switch the liquid crystal are also provided.

### BRIEF DESCRIPTION OF THE SEVERAL VIEWS OF THE DRAWINGS

The present disclosure is best understood from the following detailed description when read with accompanying figures. It is emphasized that, in accordance with the standard practice in the industry, various features are not drawn to scale and are used for illustration purpose only. In fact, the dimension of the various features may be arbitrarily increased or reduced for clarity of discussion. Some dashed lines are shown in figures are for a better understanding of descripted embodiments.

FIG. 1 is a cross-sectional view of an LCMD film structure according to an embodiment of the present disclosure with added UV absorber.

FIG. 2 is a cross-sectional view of an LCMD film apparatus with cages of framework polymer in the liquid crystal polymer matrix according to one or more embodiments of the present disclosure.

FIG. 3 shows the UVA spectrum of benzotriazoles.

FIG. 4 shows a comparison of electric-optical curves (transmissibility vs AC driving voltage) among LCMD films made by different technologies.

### DETAILED DESCRIPTION OF THE INVENTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

As used herein the term “LCMD device” or “LCMD film” or “LCMD display” means a device or film or display, respectively, formed using various classes of polymer films. For example, an LCMD device may be formed using nematic curvilinear aligned phase (NCAP) films, such as material and devices described in U.S. Pat. No. 4,435,047 filed Sep. 16, 1981 disclosing “Encapsulated Liquid Crystal and Method,” which is incorporated by reference herein in its entirety. An LCMD device may also be formed using polymer dispersed liquid crystal (PDLC) films formed using phase separation in a homogenous polymer matrix, such as material and devices described in U.S. Pat. No. 4,688,900 filed Sep. 17, 1985 disclosing “Light Modulating Material Comprising a Liquid Crystal Dispersion in a Plastic Matrix,” which is incorporated by reference herein in its entirety. An LCMD device may also be formed using a non-homogenous polymer dispersed liquid crystal display (NPD-LCD) formed using a non-homogenous light transmissive copolymer matrix with dispersed droplets of liquid crystal material, such as material and devices described in U.S. Pat. No. 5,270,843 filed Aug. 31, 1992 disclosing “Directly Formed Polymer Dispersed Liquid Crystal Light Shutter Displays,” which is incorporated by reference herein in its entirety. Other forms of liquid crystal microdroplet films may also be suitable. A NPD-LCD device may be configured in one of two modes. In a positive mode, an NPD-LCD device is switchable between an opaque state without an applied electrical voltage and clear state with an applied electrical voltage. In a negative mode, an NPD-LCD device is switchable between a clear state without an applied electrical voltage and an opaque state with an applied electrical voltage.

For better durability, LCMD film is often laminated between two pieces of glass by using an “interlayer,” which is a soft film material that may have an adhesion function when melted at a high temperature. Interlayer is a thermoplastic material which may be used to bond glass or plastic or film together through a high-temperature process, called “interlayer lamination.” Sometimes, both interlayer material or interlayer film before being used in a lamination and an internal layer formed with the interlayer material after a lamination process are called “interlayer” in the glass industry. Such interlayer-laminated LCMD panel may is used as privacy glass or a projection panel.

As used here, the term “Ultraviolet Stable and Low Voltage Liquid Crystal Microdroplet Display” is written as USLV-LCMD. The terms “switchable panel”, “switchable film”, “smart film” or “smart glass” means a device or panel component formed of at least one layer of a transparent material such as glass or a polymer material together with at least one layer of liquid crystal microdroplets dispersd in a polmer matrix. As used herein, the term “film” is understood to include traditional polymer based film, such as polyester film and acrylic film and polycarbonate film, which have a relatively flexible planar or curved format. The term “glass” is understood to include traditional silica-based glass as well as polymer-based transparent materials, such as acrylic glass and polycarbonate glass, which have a relatively rigid planar or curved format. Film or glass may be colored or include tinting. Glass may also include reinforced, toughened and laminated glasses or any other type of transparent material having higher strength, safety or other special features, such as self-cleaning. Glass may also have an anti-reflective coating or anti-glare coating on it.

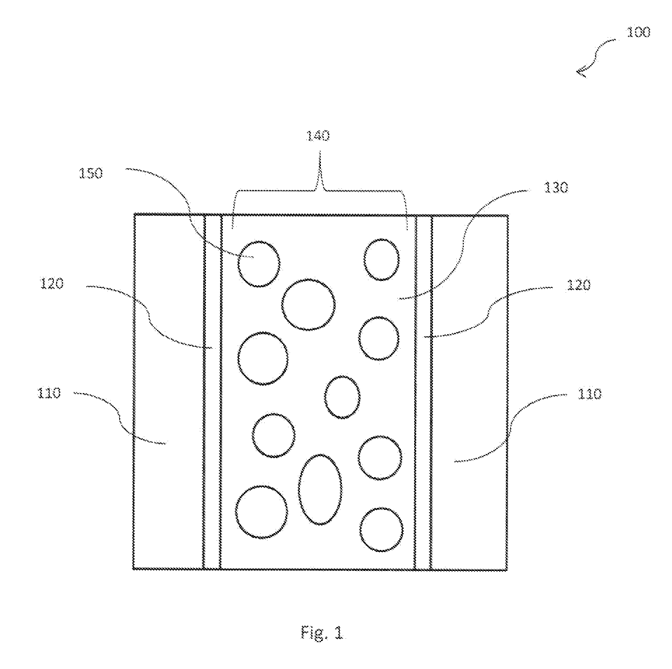

Referring to FIG. 1, a cross-sectional view of one example of an UV stable LCMD film 100 is illustrated. IN stable LCMD panel film structure 100 includes film layer 110, transparent and conductive coating 120 (e.g., an indium tin oxide (ITO) coating) and liquid crystal polymer matrix 140 which contain liquid crystal microdroplets 150 and polymer matrix 130. Liquid crystal microdroplets 150 and polymer matrix 130 may contain UV absorber(s), separately or together. Film 110 may contain UV absorber, too.

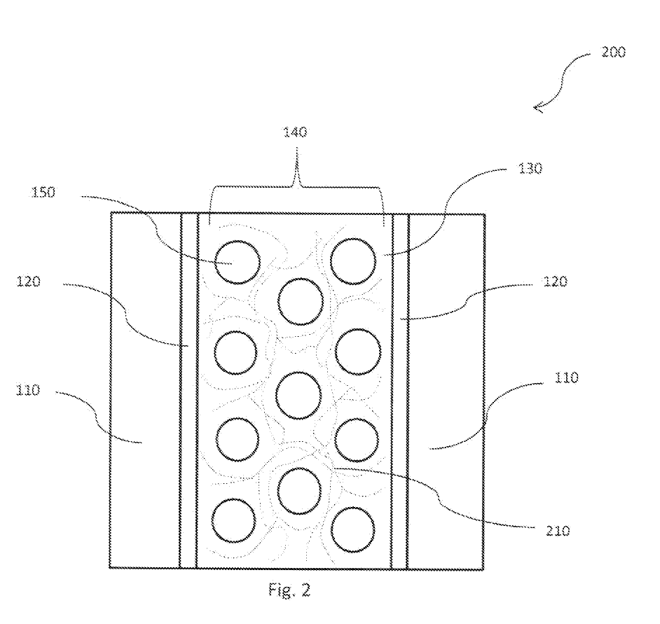

Referring to FIG. 2, a cross-sectional view of one example of an UV stable and low voltage LCMD film 200 is illustrated. USLV-LCMD film 200 structure includes film layer 110, transparent and conductive coating 120 (e.g., an indium tin oxide (ITO) coating) and liquid crystal polymer matrix 140 which contain liquid crystal microdroplet 150 and polymer matrix 130. Liquid crystal droplet microdroplet 150, polymer matrix 130 and film 110 may contain UV absorber(s), separately or together. The polymer in the polymer matrix 140 is a copolymer including framework polymer 210. The framework polymer 210 divides the entire liquid crystal into basically identical sizes of microdroplets 150.

Although LCMD material has been invented and used for many years, applications are preferably limited to indoor, because liquid crystal microdroplets 150 and polymer matrix 130 as well as polymer film 110 are vulnerable to UV damage. Ultraviolet (IV) light is electromagnetic radiation with a wavelength shorter than that of visible light, but longer than X-rays—that is, in the range between 400 nm and 10 nm, corresponding to photon energies from 3 eV to 124 eV. Many natural and synthetic polymers are attacked by ultra-violet radiation and products made using these materials may crack or disintegrate (if they're not UV-stable). The problem is known as UV degradation, and it is a common problem in products exposed to sunlight. Since application temperature range and moisture stability have been greatly improved in NPD-LCD, markets strongly need LCMD devices with a high UV stability to fit various outdoor applications. This invention discloses a method to increase UV stability for LCMD by utilizing UV absorbers or UV stabilizers in the structure of LCMD 100 and LCMD 200.

UV stabilizers are used frequently in plastics, including cosmetics, inks and films. The primary function is to protect the substance from the long-term degradation effects from light, most frequently ultraviolet radiation. Different UV stabilizers are utilized depending upon the substrate, intended functional life, and sensitivity to UV degradation. UV stabilizers, such as benzophenones, work by absorbing the UV radiation and preventing the formation of free radicals. Depending upon substitution, the UV absorption spectrum is changed to match the application. Concentrations normally range from 0.05% to 2%. UV absorbers have been used in some areas, such as for plastic, to increase material stability under UV or sunlight exposure. The UV absorbers dissipate the absorbed light energy from UV rays as heat by reversible intramolecular proton transfer. This reduces the absorption of UV rays by the polymer matrix and hence reduces the rate of weathering. Typical UV-absorbers are oxanilides for polyamides, benzophenones for PVC, benzotriazoles and hydroxyphenyltriazines for polycarbonate. Some existing UV absorbers may be used to protect LCMD and modified UV absorbers may be particularly useful and suitable for improving the anti-UV capability of LCMD and other LCDs.

The function of a UV absorber for protecting LCMD panels can be also extended into thermos-absorbers such as organosulfur compounds. Organosulfur compounds are efficient hydroperoxide decomposers, which thermally stabilize the polymers.

LCMD film comprises three parts to which UV absorbers may be added: liquid crystal microdroplets 150, polymer matrix 130 and film 110. UV absorber(s) may be added into each of these components. Since liquid crystal polymer matrix 140 is formed by a phase separation from a solution of NPD-LCD or PDLC, UV absorbers may be added into a formula for making LCMD. For NCAP, UV absorber(s) may be added into the emulsion for making NCAP.

UV absorbers include the following products. Stabilizers for polymers are used singly or in combinations to prevent the oxidation, chain fission, uncontrolled recombinations and cross-linking reactions that are caused by photo-oxidation of polymers. Polymers become weathered by the direct or indirect impact of heat and ultraviolet light. UV absorbers dissipate the absorbed light energy from UV rays as heat by reversible intramolecular proton transfer. This reduces the absorption of UV rays by the polymer matrix and liquid crystal droplets and hence reduces the rate of weathering. Following are some UV absorbers.

TABLE 1
Common UV Aborbers

| CAS No. | Chemical Name |
|---|---|
| 104810-48-2 | Hydrophilic modified benzotriazole (mixture) |
| 104810-47-1 | |
| 147315-50-2 | 2-(4,6-Diphenyl-1,3,5-triazin-2-yl)-5-((hexyl)oxy)-phenol |
| 70356-09-1 | Avobenzone |
| 70321-86-7 | 2-(2H-benzotriazol-2-yl)-4,6-bis(1-methyl-1- |
| | phenylethyl)phenol |
| 70321-86-7 | 2-(2H-benzotriazol-2-yl)-4,6-bis(1-methyl-1- |
| | phenylethyl)phenol |
| 5232-99-5 | Etocrilene |
| 6197-30-4 | Octocrilene |
| 23949-66-8 | N-(2-ethoxyphenyl)-N′-(2-ethylphenyl)oxamide |
| 3846-71-7 | 2-Benzotriazol-2-yl-4,6-di-teri-butylphenol |
| 3896-11-5 | Bumetrizole |
| 3864-99-1 | 2,4-Di-tert-butyl-6-(5-chlorobenzotriazol-2-yl)phenol |
| 25973-55-1 | 2-(2H-benzotriazol-2-yl)-4,6-ditertpentylphenol |
| 3147-75-9 | Octrizole |
| 103597-45-1 | Bisoctrizole |
| 125304-04-3 | 2-(2H-benzothiazol-2-yl)-6-dodecyl-4-methylphenol, |
| | branched |
| 23328-53-2 | and linear |
| 104487-30-1 | |
| 1843-05-6 | Octabenzone |
| 2440-22-4 | Drometrizole |

Although many UV absorbers are commercially available, only a few of them are suitable for LCMD application without reducing the performance of an LCMD device, because LCMD is very sensitive to the UV-absorber's molecular structure, physical properties and chemical stability in the liquid crystal environment. A UV absorber added into an LCMD system must have molecular structures similar to the structure of liquid crystals. Otherwise, the LCMD system will treat the UV absorbers as an impurity, which reduces performance, such as narrowing the application temperature range. UV absorbers having similar structures to the liquid crystal are suitable to add into LCMD at higher concentrations without affecting optical performance. If the structures of UV absorbers are different from the structures of liquid crystals, the absorber may reduce or destroy the optical function of the LCMD material.

In general, nematic liquid crystals used in LCMD have a characteristic of molecular structure, or a rod like structure having a “body” and “tail”. The body may have some degree of polarity or induced polarity. The body is usually formed by rigid rings, and the tail is formed by a flexible aliphatic chain. For example, the components of Merck liquid crystal E7 have the following structure:

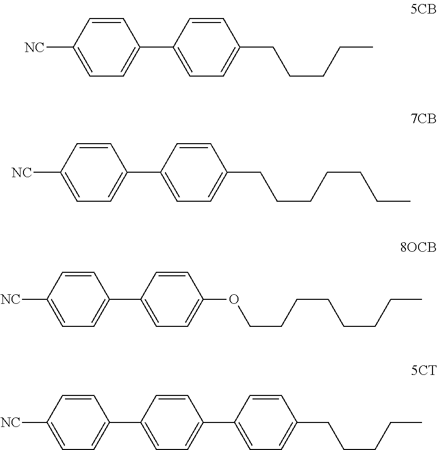 [SMILES: CCCCCc1ccc(-c2ccc(C#N)cc2)cc1 ; CCCCCCCc1ccc(-c2ccc(C#N)cc2)cc1 ; CCCCCCCCOc1ccc(-c2ccc(C#N)cc2)cc1 ; CCCCCc1ccc(-c2ccc(-c3ccc(C#N)cc3)cc2)cc1]

Liquid crystals E7 is widely used in the study of LCD. It offers a range of operating temperatures. It exhibits a nematic phase from −62° C. to +58° C. and contains the following compounds at the listed percentage compositions shown.

TABLE 2
Components and mass composition of the Merck E7 liquid crystal

| | Molecular | | Composition | TNI |
|---|---|---|---|---|
| Designation | formula | IUPAC name | (w/w) | (° C.) |
| 5CB | C18H19N | 4-cyano-4′-pentyl-1,1′- | 51% | 35.3 |
| | | biphenyl | | |
| 7CB | C20H23N | 4-n-heptyl- | 25% | 42.8 |
| | | 4′cyanobiphenyl | | |
| 8OCB | C21H25NO | 4,4′-n- | 16% | 80 |
| | | octyloxycyanobiphenyl | | |
| 5CT | C24H23N | 4′n-pentyl-4- | 8% | 240 |
| | | cyanotriphenyl | | |

A simple way to protect organic material against UV light is to prevent UV absorption, i.e. reducing the amount of light absorbed by chromophores. This can be achieved by incorporating UV absorbers in the adhesives, which function by preferentially absorbing harmful untraviolet radiation and dissipating it as thermal energy. Such stabilizers function according to the Beer Lambert law, which specifies that the amount of UV radiation absorbed is a function of both sample thickness and stabilizer concentration. In practice, high concentrations of absorbers and sufficient thickness of the polymer are required before enough absorption takes place to effectively retard photodegradation. Benzophenone and benzotriazole are the main UV absorbers used in adhesives and sealants.

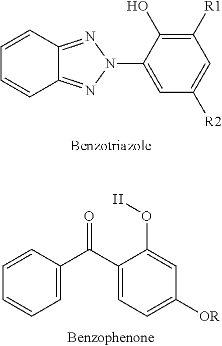

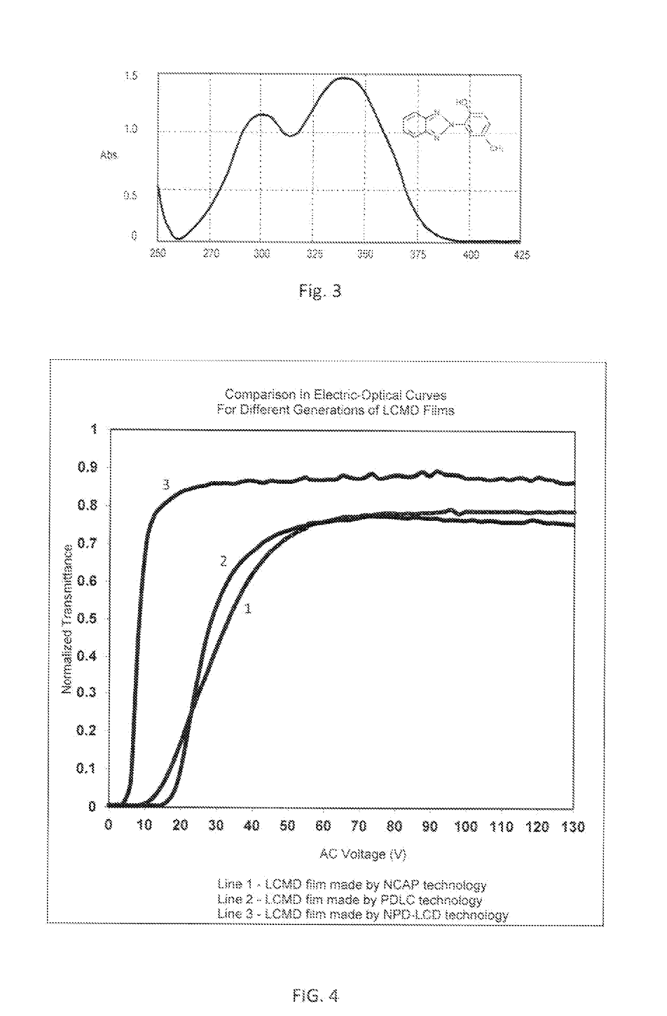

The different substituents in the benzotriazole group affect various properties, such as polarity, volatility, compatibility, physical condition and—last but not least—maximum absorption levels. Typical UV absorption spectra of benzotriazoles can be seen in illustration FIG. 3.

FIG. 3 absorption curves show that the requirements are met: strong absorption in the UV range between 295 and 400 nm and a large reduction in absorption in the visible range above 400 nm. The typical protection mechanism of benzotriazoles and benzophenones are illustrated in the schemes below.

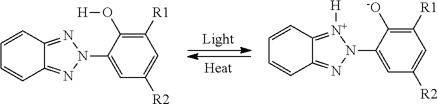

UV absorption causes the electron density to move from the phenolic oxygen to the nitrogen atom. The nitrogen becomes more alkaline than the oxygen as a result and a proton transfer occurs. This mesomeric form represents an excited state, which stabilizes as a result of a radiationless transition to the ground state.

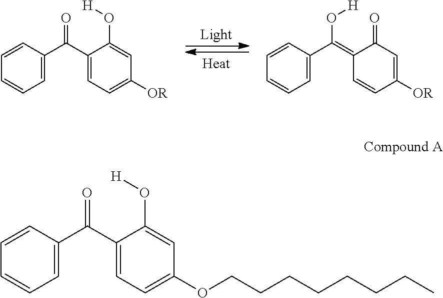

The molecular structure of benzophenone is quite close to structures of the components of liquid crystals if the proper aliphatic chains are used. If substituent R is an aliphatic chain with 5 to 10 carbon atoms, the benzophenones have very similar molecular shape to liquid crystals used in LCMD. If R in benzophenone is the aliphatic group C₈H₁₇, compound A has all characteristics of a liquid crystal molecule with a rigid body and flexible tail and polarity of the body. Therefore, it may be used in a higher concentration in E7 or LCMD to provide better protection. In normal applications of UV absorbers, addition of 0.5% to 2% of this UV absorber works. When such a similar structure is used, usage higher than 2 percent by weight is possible—even 5 to 10 percent by weight. This ensures that adding the UV absorbers does not affect the original optical performance. Since the benzophenone is a ketone and has both ketone and hydroxyl groups, addition of the benzophenone may improve solubility of the liquid crystals, which may widen the temperature range of the liquid crystals.

For similar structures of benzophenone, many derivatives may be designed and used. For example, a substituent may be on each or both benzene rings of benzophenone. The substituent may have different length of chain containing 1 carbon to 18 carbons at different position on the benzene ring. Similarly, other UV absorbers with a rod like shape may be used as base molecules to design UV-stabilizer liquid crystals.

When adding UV absorber(s) into the formula of LCMD, the absorbers may be automatically distributed into both liquid crystal microdroplet 150 and polymer matrix 130, because phase separation cannot make any component 100% out of solid phase. Therefore, both liquid (crystal) phase and solid (polymer rich) phase contain the UV absorbers. In this way, the entire liquid crystal polymer matrix 140 is protected by IN absorbers.

Since designed derivatives of benzophenones with aliphatic substituents have highly similar molecular structures to liquid crystals, the derivatives may become a new type of liquid crystal component having a good solubility and anti-ultraviolet capability. Such kind of liquid crystal components may be used for many applications, such as TV and monitor and hand-held and other mobile devices. It is a great advantage to include this kind of liquid crystal component for outdoor applications. It is suitable when organic dye is used in any kind of LCD, because most organic dyes are vulnerable for UV. Table 3 shows results of sun tests for different LCMD films without any protection for UV stability and one with protection. The result indicates that using UV absorbers in LCMD film may greatly extend product lifetime.

TABLE 3
Sun Test Comparison in opacity for UV stability

| Type of LCMD Film | 1 month | 4 month | 28 month |
|---|---|---|---|
| NCAP film | Failure | | |
| PDLC film | Failure | | |
| NPD-LCD film | Good | Reduced | Failure |
| Without UV absorber | | | |
| NPD-LCD film | Good | Good | Good |
| With UV absorber | | | |

On the other hand, in order to achieve outdoor applications for LCMD, energy consumption must be considered seriously, because of a possible large area coverage. Reducing driving voltage is the most efficient way to reduce energy consumption of using LCMD. By analyzing all different generations of LCMD, it is easy to find that NPD-LCD and PDLC made by phase separation requires lower driving voltage than NCAP made by emulsion. There is a research method of which LCMD glass devices may be formed by phase separation through temperature cooling. Resulting LCMD devices require very low driving voltage or have a steeper electric-optic curve. In this process, phase separation occurs by reducing temperature to reduce solubility. However, this method is not suitable for industrial mass production or for using film as substrate, because it requires very high temperature (above 300° C.) to melt polymers. However, this method indicates that it is possible to make highly identical sizes of droplets while providing the sane environments around droplets and the resulting LCMD requires very low driving voltage.

It is known that driving voltage is related to sizes of single droplet by the following equation:

$${V}_{s} = \frac{d}{3 a} ( \frac{{ρ}_{p}}{{ρ}_{lc}} + 2 ) \sqrt{\frac{K ( {l}^{2} - 1 )}{Δɛ {ɛ}_{o}}}$$

where Vₛ is switching or driving voltage for a bipolar droplet, d is sample thickness, α is the droplet radius, l is the droplet aspect ratio, K is the mean elastic constant of the liquid crystal, ρₚ and ρ_{lc} we the resistivities of polymer and liquid crystal regions respectively, and Δ∈ is the dialectic anisotropy of the liquid crystal. All droplets in an LCMD do not switch simultaneously because of different droplet sizes and shapes.

The above equation shows that switching voltage is inversely proportional to droplet size (radius α). The larger the size is, the lower the voltage required. When a system has a large range of size distribution, the electric-optical cure is less steep. In an NCAP system, mechanically produced droplets in an emulsion have a very large distribution in size. In general, droplet sizes could vary several-fold; therefor, NCAP film requires a high voltage to turn on small sizes of droplets to obtain a good transparency of the film. LC droplets formed by phase separation in NPD-LCD and PDLC systems have better uniformity in size in comparison with the NCAP emulsion system. Therefore, driving voltages of LCMD formed by phase separation is lower than that formed by an emulsion. The wider the distribution of droplet sizes is, the larger the range of driving voltages required. The large range of driving voltages gives a non-steep voltage/transmission curve, which is not suitable for multiplexing. Obtaining a high slope of the electro-optical (E-O) curve for LCMD may greatly enlarge applications as digital displays with multiplex driving.

However, phase separation currently occurring in NPD-LCD or PDLC systems cannot provide low enough driving voltage. From phase separation diagrams, we know that droplet size is related to the surrounding condition, such as concentrations of components. Liquid centers generated at different times have different surrounding conditions. This causes different droplet sizes.

For one or more embodiments, the present disclosure shows a novel method which may effectively control droplets to almost identical sizes; therefore, the LCMD requires very low voltage to drive and has a very steep voltage/transmission curve or electro-optical (E-O) curve.

The mechanism to make this phenomenon happen involves a key component, called a “dissolved framework polymer,” in the curing process. In the normal curing situation of the NPD-LCD or the PDLC process, monomers gradually undergo a polymerization to extend their chain length, causing the viscosity to gradually increase and the solubility to gradually decrease. The system creates many phase separation centers to form LC droplets, which start at different times and different locations. The earlier started centers have more chance to grow bigger or merge, because the viscosity, time and adjacent material resource are more favorable, but the later-started liquid centers have less chance to grow. Therefore, a wide range of droplet sizes is formed during the entire period of phase separation and curing.

To better understand the mechanism described in the present disclosure, it is better to review some phenomena and experiments. In general, polymers are not easily dissolved, but it depends on solubility between solute and solvent. For example, acrylic glass or poly(methyl methacrylate) may be dissolved into the solvent chloroform. A solution of poly(methyl methacrylate) and chloroform may be a transparent jelly. When some solvent chloroform is evaporated from the solution slowly, the jelly becomes thicker but still remains transparent. This indicates that poly(methyl methacrylate) may form a chloroform solution in any concentration. Another example is gelatinized starch jelly. Like many other polymers, starch is in crystalline form. Crystalline regions do not allow water entry. Hot water may break down the intermolecular bonds of starch molecules and allow the hydrogen bonding sites to engage more water. Heat causes crystalline regions to become smaller, so that the chains begin to separate into an amorphous form.

Formation of LCMD involves multi components, including liquid crystals and monomers or oligomers. Liquid crystals usually consist of four to ten different molecules. The multicomponent system may undergo a simple phase separation with only two phases or liquid and solid phase. Liquid crystal droplets are in the liquid phase and the polymer matrix is the solid phase. The multi-component system may be designed to have a complex phase separation temporarily involving three phases, mother solution, liquid droplet and solid polymer, in its process of phase separation. A solution of liquid crystals and monomers may generate two new phases or liquid crystal droplets and solid polymer separated from mother solution. This complex phase separation may prevent liquid crystal droplets from merging, thereby controlling the size of liquid crystal droplets. Therefore, it has an important advantages in improving the quality of LCMD devices.

In one or more embodiments of the present disclosure, some special compounds are designed and selected to form a polymer which may be dissolved in the mother solution. In order to achieve such purpose, we have to carefully design their molecular structures and properties, including reactivity, reactive functional groups, non-reactive functional groups and flexible long chains. A high reactivity is needed to ensure forming a polymer faster than other components. For example, the reactivity difference among aromatic epoxy and aliphatic epoxy and the epoxycyclohexyl group may be utilized for this purpose. Multiple reactive functional groups may act like centers of cross-link. The amount of compounds with multi-functional groups is critical. A long flexible chain is favorable to form jelly type of polymer matrix. High cross linking may result an earlier phase separation to occur. A non-reactive functional group may help improve solubility, which is very important in this process. Since this is a liquid crystal mixture, the non-reactive functional group may be selected to be the same or a close functional group to that in liquid crystals. These requirements are favorable to form a polymer long chain which has a high solubility in the mother solution. The following commercially available compounds have the mentioned features.

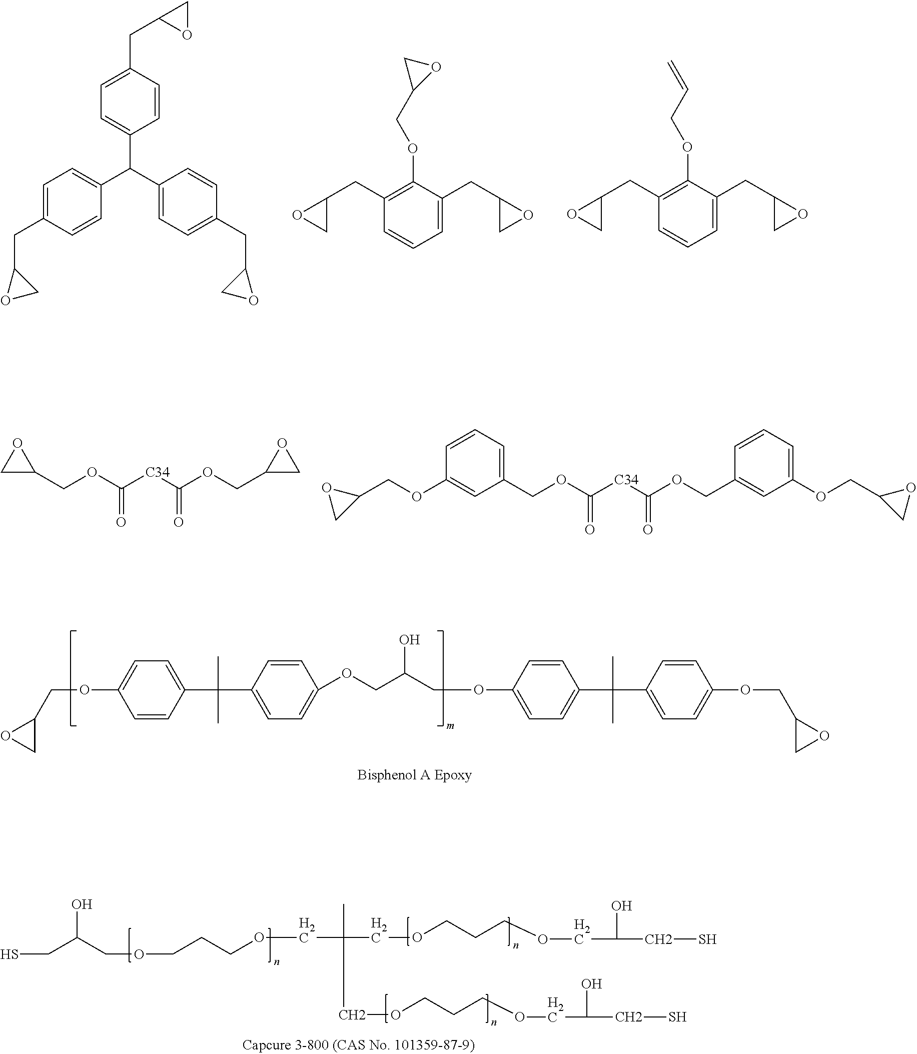

A newly formed polymer may have a high solubility to its mother solution containing liquid crystals and other monomers. High temperature is favorable to dissolve the newly formed polymer into the mother solution. It is possible that first phase separation may occur to form a new solid phase. Early-formed solid phase is similar to gelatinized starch distributed in water. During phase separation, the mother solution acts as a plasticizer. Liquid crystals and monomers are absorbed in the amorphous space of newly-formed polymer, which leads to a swelling phenomenon under a raised temperature to prevent forming crystalline regions in the structure of the newly formed polymer. For example, components in the mother solution enter tightly bound amorphous regions to swell amylopectin, thus preventing crystalline structures to form. Stress caused by this swelling phenomenon eventually interrupts structure organization and allows for leaching of amylose molecules to surrounding components. In this way, the entire system forms a jelly matrix. At this stage, the newly formed polymer forms a framework in the system, called framework polymer 210 (FIG. 2). The framework polymer may be ether dissolved in mother solution or separated already from mother solution, but in a highly-swelled and highly-distributed condition. A polymer framework is formed before phase separation begins. This framework polymer is newly formed from the mother solution and dissolved in the mother solution at the beginning. When phase separation starts, the framework polymer is first separated from the mother mixture and divides the system into many equal sized small regions, like many cages. Each of the small regions only allows forming one droplet in it. Since the framework polymer is uniformly distributed and all regions are identical, the final droplets formed are highly uniform in size.

Such a situation creates an important condition to control growth of droplets. Since the framework is uniformly distributed, once the system starts to form new liquid phase or liquid centers for microdroplets, the framework polymer affects the liquid centers. The framework polymer separates the entire system into many identical regions. It is believed that this mechanism forms a polymer cage around liquid centers, isolating droplets to prevent merging and also preventing formation of new liquid center in new locations. Such cages also may control size of liquid crystal droplets by controlling concentration of framework polymer and its degree of crosslinking. Since each cage only allows forming one droplet, droplet size may be highly uniform. For the same reasons, droplet shape is near round, because surrounding conditions to a droplet are the same. According to the above equation of driving voltage of a single droplet, both unified droplet size and round shape are greatly helpful in achieving low-voltage driving.

In the later stage of polymerization or curing, such basic structure will be kept. When mother liquid phase has gradually disappeared, the liquid phase of liquid crystal droplets and the solid phase of the polymer matrix are becoming more pure. Finally, all reactive molecules become a part of the solid phase, and most non-reactive components go to the liquid phase inside of droplets. Some non-reactive components remain in the solid phase as plasticizers.

A key to achieve such structure is the solubility of the framework polymer. Since selecting liquid crystals is mainly dependent on their optical and physical properties and selecting polymer including framework polymer is mainly depended their chemical reactivity, it is always difficult to meet both chemical requirements and physical requirements, including optical requirements, and achieve a good solubility. The structure of benzophenones provides a great help, because it contains a ketone group, a hydroxyl phenolic group and a benzene ring. It is well-known that the ketone group has powerful solubility for many kinds of chemicals. In the present disclosure, ketone is used not only as a UV absorber, but also a solubility promoter. Furthermore, special designed benzophenons derivative may be directly used as a liquid crystal, therefore, this concentration of use may reach to a high level in comparison with normal use of UV absorbers.

FIG. 4 shows a comparison in electric-optical curves among LCMD films made by different technologies. Normalized transmittance is shown for different values of AC driving voltage applied to an LCMD film. Curve 1 shows values of the electric-optical (E-O) relationship for a film made by NCAP technology. Curve 2 shows values of the E-O relationship for a film made by PDLC technology. Curve 3 shows values of the E-O relationship for a film made by NPD-LCD technology and including a dissolved framework polymer in the mixture used to form the LCMD material. The dissolved framework polymer may be formed from monomers selected from those discussed above.

The new system of NPD-LCD utilizes “a dissolved framework polymer” to achieve highly identical sizes of microdroplets. The film made by NPD-LCD technology was fully turned on at a voltage of less than 10 V AC, whereas the films made by prior techniques required voltages in the 50 to 60 volt range to reach maximum transmittance. This large reduction in voltage required to switch the liquid crystal in microdroplets means that power requirements for LCMD devices can be greatly reduced by using the materials and methods taught herein.

In older technologies like NCAP and PDLC, the uniform polymer matrix has considerable solubility in the liquid crystal, acting as a plasticizer. The liquid crystal phase or microdroplets also contain some of dissolved polymer as an impurity. Such situation reduces the operational temperature range of NCAP film and PDLC film, which is usually within a range of 0° C. to 50° C. Since the center regions of polymer matrix are formed containing framework polymer, which has a very high degree of polymerization in NPD-LCD film, these regions have a very low solubility to liquid crystal as a plasticizer. Liquid phase or microdroplet is much purer than uniform polymer matrix in NCAP or PDLC matrixes, and results a much wider operational temperature range, such as from −30° C. to 80° C. Purer liquid crystal phase also enlarges birefringence between two different orientations of liquid crystals and results a higher scattering or opacity.

In order to have UV absorber function, UV absorber having reactive functional group may be used in a LCMD formula. Such compounds, such as compound B series and compound C series, containing both UV absorbing group and reactive group to polymer matrix will remain in polymer matrix and have its protection effect.

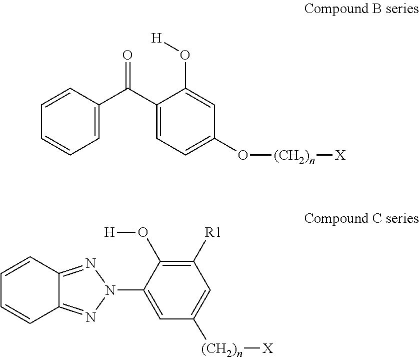

In the compound B series, X is a reactive functional group depending on the type of polymer matrix used. It may contain 1 to 10 carbons. In the compound C series, R1 may be an alkyl group.

UV absorber may be also put into plastic film 110 (FIG. 1). Polyester UV protected film is commercially available, such as Mitsubishi film, Hostaphan 4333UV and 7333UV.

LCMD has been used for over a quarter of a century. Most LCMD film 110 are made of polyester film or PET (polyethylene terephthalate). For outdoor use, polycarbonate film should be better for UV resistance and weathering.

Although the present invention has been described with respect to specific details, it is not intended that such details should be regarded as limitations on the scope of the invention, except to the extent that they are included in the accompanying claims.

I claim:

1. A Liquid Crystal Micro-Droplet (LCMD) panel, comprising:
a polymer matrix, wherein the polymer matrix contains a compound selected to absorb energy from ultraviolet radiation to go to an excited state and release heat upon return from the excited state to a ground state; and
droplets of a first liquid crystal material dispersed in the polymer matrix.

2. The panel of claim 1 further comprising a compound selected to absorb ultraviolet radiation in the droplets of liquid crystal.

3. The panel of claim 1 further comprising a film in contact with the polymer matrix, the film containing a compound selected to absorb ultraviolet radiation.

4. The panel of claim 2 wherein the selected compound forms a liquid crystal before it is added to the first liquid crystal material.

5. The panel of claim 2 wherein the first liquid crystal material is selected to absorb ultraviolet radiation.

6. The panel of claim 2 wherein the compound is benzophenone or a derivative of benzophenone or benzotriazole.

7. A liquid mixture for forming an LCMD material by phase separation comprising a compound selected for absorption of UV radiation.

8. The mixture of claim 7 wherein the compound comprises a conjugated system including two or more double bonds and an aliphatic hydrocarbon chain reacted with an aromatic group, the hydrocarbon chain having a number of carbon atoms in the range of 3 to 10.

9. The mixture of claim 7 wherein the compound is selected from derivatives of benzophenone or benzotriazole.

10. The mixture of claim 7 further comprising monomers or polymers selected to form a dissolved framework polymer before or during phase separation of the mixture.

11. The mixture of claim 10 wherein the monomers or polymers comprise bisphenol A or Capcure 3-800.

12. A method for making a Liquid Crystal Micro-Droplet material, comprising:
forming a liquid mixture comprising a compound selected for absorption of UV radiation and components selected to form liquid crystal microdroplets in a polymer matrix; and
causing a phase separation to form solid matrix containing micropdroplets of liquid crystal material.

13. The method of claim 12 further comprising adding to the mixture a monomer or polymer selected to at least partially polymerize before the polymer matrix becomes a solid and function as a dissolved framework polymer.

14. The method of claim 13 wherein the monomer or polymer is selected from bisphenol A or Capcure 3-800.

15. A Liquid Crystal Micro-Droplet (LCMD) film, comprising:
a polymer matrix; and
droplets of a liquid crystal material dispersed in the polymer matrix, wherein the panel is switched from a minimum value of transmittance to a maximum transmittance by application of an AC voltage of less than 30 volts.

16. A liquid crystal compound for forming a liquid crystal display, comprising:
a conjugated system for absorbing UV radiation to go to an excited state and releasing heat to return to a ground state; and
a flexible hydrocarbon chain having a number of carbon atoms in the range of 3 to 10.
